(19) United States
(12) Patent Application Publication
(10) Pub. No.: US 2025/0357516 A1
(43) Pub. Date: Nov. 20, 2025

(54) ADDITIVES FOR FERROCYANIDE OR FERRICYANIDE ELECTROLYTES

(71) Applicant: OTORO ENERGY, INC., Boulder, CO (US)

(72) Inventors: Jessica A. MURDZEK, Boulder, CO (US); Brian H. ROBB, Boulder, CO (US); Michael MARSHAK, Boulder, CO (US)

(21) Appl. No.: 19/210,514

(22) Filed: May 16, 2025

Related U.S. Application Data
(60) Provisional application No. 63/648,578, filed on May 16, 2024.

(51) Int. Cl. H01M 8/08; H01M 8/18

(52) U.S. Cl. CPC H01M 8/08; H01M 8/188

(57) ABSTRACT

An aqueous electrolyte solution having an increased or decreased concentration of ferrocyanide is described. The increased or decreased concentration of ferrocyanide in the aqueous electrolyte solution is possible by virtue of the inclusion in the electrolyte solution of a polyion additive. The ferrocyanide component of the aqueous electrolyte solution may be sodium ferrocyanide, potassium ferrocyanide, or a combination thereof. The polyion polymer additive component of the aqueous electrolyte solution may a polycation or a polyanion. An aqueous electrolyte solution having an increased or decreased concentration of ferricyanide is also described.

### CROSS-REFERENCE TO RELATED APPLICATION(S)

This application claims priority to U.S. Provisional Patent Application No. 63/648,578, entitled ADDITIVES FOR FERROCYANIDE ELECTROLYTES, filed May 16, 2024, the entirety of which is hereby incorporated by reference.

### TECHNICAL FIELD

This disclosure relates to the use of an additive that is added to a potassium and/or sodium ferrocyanide solution which thereby enables more or less of the sodium or potassium ferrocyanide solids to dissolve in the solution.

This disclosure further relates to the use of an additive that is added to a potassium and/or sodium ferricyanide solution which thereby enables more or less of the sodium or potassium ferricyanide solids to dissolve in the solution.

### BACKGROUND

Potassium or sodium ferrocyanide can be used as an electrolyte in chemical energy storage systems, including in aqueous flow batteries. However, the maximum solubility of potassium or sodium ferrocyanide in water limits the concentration of potassium or sodium ferrocyanide in water to less than 0.8 M, which limits the energy density of the aqueous electrolyte compositions based on potassium or sodium ferrocyanide. The oxidized species of ferrocyanide, ferricyanide, is well known to be the more soluble of the two species. In flow battery electrolytes, where the electrolyte is converted between the oxidized and reduced species, the ferrocyanide solubility is considered the species that limits the overall electrolyte solubility in solution. If the concentration of the active species (ferrocyanide) in the electrolyte solution was higher, then less electrolyte solution would be needed to power the battery. Sometimes, it can be advantageous for the concentration of the active species (ferrocyanide) in the electrolyte solution to be very low or even insoluble in order to isolate solids or gels of the ferrocyanide for purposes such as redox mediation.

Attempts at increasing the solubility of ferrocyanide in aqueous electrolyte solutions have been previously made, but these attempts have primarily focused on either changing the mono-cation associated with the ferrocyanide, for instance using Li⁺, Ca²⁺, or NH₄⁺, or on mixing two different mono-cation ferrocyanides, such as a mixture of K⁺ and Na⁺ ferrocyanide. However, both of these approaches have drawbacks. With respect to changing the mono-cation associated with the ferrocyanide, a different cation such as Li+ Ca+ or NH4+ can have a lower conductivity in solution and impact the ability of batteries to cycle at high efficiency. Additionally, the cost of these other mono-cations can be expensive, thus increasing the cost of the electrolyte solutions. With respect to using multiple cations in a ferrocyanide solution in a flow battery, this will result in the two cations moving across the membrane at different rates. This often creates problems where the ratio of one cation to the other cation is different on each side of the membrane, or movement of the cations back and forth across the membrane is reduced, resulting in worse battery performance.

Accordingly, a need continues to exist for aqueous electrolyte solutions with increased active species concentration.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Described herein are various embodiments of an aqueous electrolyte solution having an increased or decreased concentration of ferrocyanide by virtue of the inclusion in the electrolyte solution of an additive that increases or decreases ferrocyanide solubility in the aqueous electrolyte solution. Surprisingly, small weight percents of these additives can dramatically increase or decrease the solubility of the ferrocyanide. In some embodiments, the aqueous electrolyte solution comprises one or more ferrocyanide and an additive to increase or decrease the solubility of the one or more ferrocyanide in the aqueous electrolyte solution. In some embodiments, the one or more ferrocyanide is sodium ferrocyanide, potassium ferrocyanide, or a combination thereof. In some embodiments, the additive is a polyion polymer. In some embodiments, the polyion polymer is a polyanion polymer. In some embodiments, the polyion polymer is a polycation polymer.

Also described herein are various embodiments of an aqueous electrolyte solution having an increased or decreased concentration of ferricyanide by virtue of the inclusion in the electrolyte solution of an additive that increases or decreases ferricyanide solubility in the aqueous electrolyte solution. Surprisingly, small weight percents of these additives can dramatically increase or decrease the solubility of the ferricyanide. In some embodiments, the aqueous electrolyte solution comprises one or more ferricyanide and an additive to increase or decrease the solubility of the one or more ferricyanide in the aqueous electrolyte solution. In some embodiments, the one or more ferricyanide is sodium ferricyanide, potassium ferricyanide, or a combination thereof. In some embodiments, the additive is a polyion polymer. In some embodiments, the polyion polymer is a polyanion polymer. In some embodiments, the polyion polymer is a polycation polymer.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a graph showing the concentration of potassium ferrocyanide in an aqueous electrolyte solution at varying amounts of polycation additive (PDADMAC) quantities.

FIG. 2 is a graph showing the concentration of sodium ferrocyanide in an aqueous electrolyte solution at varying amounts of polycation additive (PDADMAC) quantities.

FIG. 3 is a graph showing the concentration of combined potassium ferrocyanide and sodium ferrocyanide in an aqueous electrolyte solution at varying amounts of polycation additive (PDADMAC) quantities.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

In some embodiments, an aqueous electrolyte solution generally comprises one or more ferrocyanides and an additive, wherein the additive is one or more polyion polymers, such as one or more polycation polymers, one or more polyanion polymers, or a combination of one or more polycation polymer and one or more polyanion polymers. The ferrocyanide may be sodium ferrocyanide, potassium ferrocyanide, or a combination thereof. Some polyion polymer additives increase the solubility of the ferrocyanide component or components of the aqueous electrolyte solution. As a result of the increased solubility, the concentration of the active species (ferrocyanide) in the electrolyte solution is increased, and as such, less electrolyte solution is needed to power a battery. Some polyion polymer additives decrease the solubility of the ferrocyanide component or components of the aqueous solution may be decreased. As a result of the decreased solubility, solids or gels of the ferrocyanide can be isolated for purposes such as redox mediation.

The ferrocyanide component of the aqueous electrolyte solution is, in some embodiments, either sodium ferrocyanide, potassium ferrocyanide, or a combination of both sodium ferrocyanide and potassium ferrocyanide. Additional ferrocyanides may be included in the aqueous electrolyte solution, but typically only as supplements to the sodium ferrocyanide and/or potassium ferrocyanide. In some embodiments, these supplemental ferrocyanides are selected from lithium ferrocyanide, calcium ferrocyanide, ammonium ferrocyanide, or any combination thereof. In one non-limiting example, the aqueous electrolyte solution comprises both sodium ferrocyanide and potassium ferrocyanide and at least one additional supplemental ferrocyanide (e.g., one or more of lithium ferrocyanide, calcium ferrocyanide, and ammonium ferrocyanide). When a supplemental ferrocyanide is included in the aqueous electrolyte solution, the amount of supplemental ferrocyanide included in the aqueous electrolyte solution is less than the amount of primary ferrocyanide (i.e., sodium ferrocyanide, potassium ferrocyanide, or combination thereof).

The additive component of the aqueous electrolyte solution is one or more polyion polymers. Polyions are polyelectrolytes (polymers whose repeating unit bears an electrolyte) having a positive or negative charge. A polyion bearing a positive charge is a polycation. A polyion bearing a negative charge is a polyanion. The polyion polymer additive included in the aqueous electrolyte solution may be one or more polycation polymers, one or more polyanion polymers, or a combination of one or more polycation polymers and one or more polyanion polymers.

When the additive includes one or more polycation polymers, any suitable polycation or polycations can be used. In some embodiments, a polycation polymer used as an additive comprises one or more functional groups, such as one or more functional groups selected from the group consisting of amines, imidazoles, pyridiniums, phenols, amides, ammonium groups, phosphonium groups, sulfonium groups, nitronium groups, and carbonyls. The polycation polymer may also include any other functional groups that can serve as a buffer.

In some embodiments, the polycation or polycations used in the aqueous electrolyte solution are polyquaterniums. The chemical structure of the polyquaternium suitable for use in the aqueous electrolyte solution described herein may be as follows:

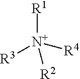

When the additive is a polyquaternium, any suitable polyquaternium may be used, including any of polyquaternium-1 through polyquaternium-47, including any combination of polyquaternium.

When the additive includes one or more polyanion polymers, any suitable polyanion or polyanions can be used. In some embodiments, a polyanion polymer used as an additive comprises one or more functional groups, such as one or more functional groups selected from the group consisting of amines, carboxylic acids, phosphates, imidazoles, phenols, amides, sulfates, nitrates, hydroxides, carbonates, dichromates, chromates, thiosulfates, dihydrogen phosphates, oxalates, carbonyls, and saccharides. In some embodiments, the polyanion polymer is selected from the group consisting of polysaccharides, poly(carboxylates), poly(phosphates), and poly(sulfates).

The use of some polyion polymers as additive may generally help achieve an increase in ferrocyanide concentration in the aqueous electrolyte solution. A non-limiting example of a polyion that increases ferrocyanide concentration in the aqueous electrolyte solution is polyquaternium-6 (poly(diallyldimethylammonium chloride) (PDADMAC)).

The use of some polyion polymers as an additive may generally help achieve a decrease in ferrocyanide concentration in the aqueous electrolyte solution. In some embodiments, the decrease in solubility occurs when the ferrocyanide is oxidized to the corresponding ferricyanide. As a result of the decreased solubility, solids or gels of the ferrocyanide can be isolated for purposes such as redox mediation. A non-limiting example of a polyion that decrease ferrocyanide concentration in the aqueous electrolyte solution is polyquaternium 7 (poly(acrylamide-co-diallyldimethylammonium chloride)). The solubility of sodium ferrocyanide and potassium ferrocyanide decreases with as little as 1% polyquaternium 7 added.

The amount of polyion additive included in the aqueous electrolyte solution is generally sufficient to increase or decrease the solubility of the ferrocyanide in the aqueous electrolyte solution. In some embodiments, a quantity of at least 0.2 wt. % of polyion additive in the aqueous electrolyte solution shows in increase or decrease in the solubility of ferrocyanide in the aqueous electrolyte solution. In some embodiments, the amount of polyion additive in the aqueous electrolyte solution is greater than 1 wt. %, greater than 2 wt. %, greater than 3 wt. %, or greater than 4 wt. % of the aqueous electrolyte solution. Increasing the amount of polyion additive in the aqueous electrolyte solution can generally allow for an increase or decrease in the concentration of ferrocyanide in the aqueous electrolyte solution. In some embodiments where increased ferrocyanide concentration is desired, the type and quantity of additive used can increase the concentration of ferrocyanide in the aqueous electrolyte solution to greater than 0.7 M. For example, when the aqueous electrolyte solution includes greater than 3 wt. % polyion additive, the concentration of ferrocyanide in the aqueous electrolyte solution can increase to equal to or greater than 1.6 M, equal to or greater than 1.8 M, or equal to or greater than 2.2 M.

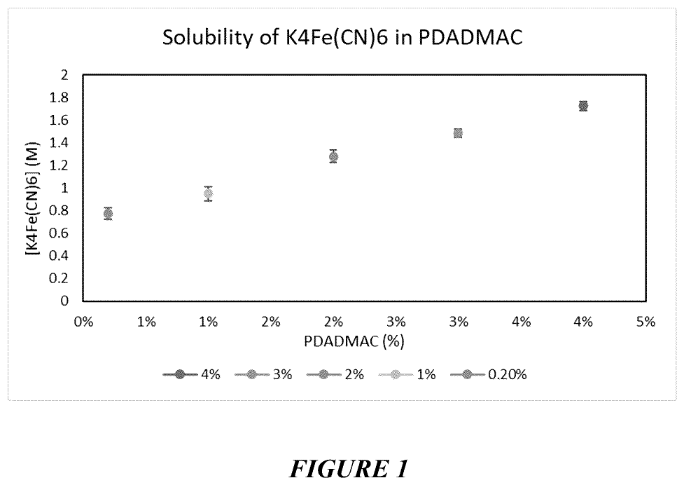

FIG. 1 is a graph illustrating the impact of an increased wt. % of polyion additive on the concentration of ferrocyanide in an aqueous electrolyte solution configured in accordance with embodiments described herein. More specifically, the aqueous electrolyte solution of FIG. 1 includes potassium ferrocyanide and PDADMAC. The graph of FIG. 1 shows how as the amount of PDADMAC additive in the aqueous electrolyte solution increases (from 0.2 wt. % to 4 wt. %), the possible concentration of potassium ferrocyanide increase from about 0.8 M to as much as 1.8 M.

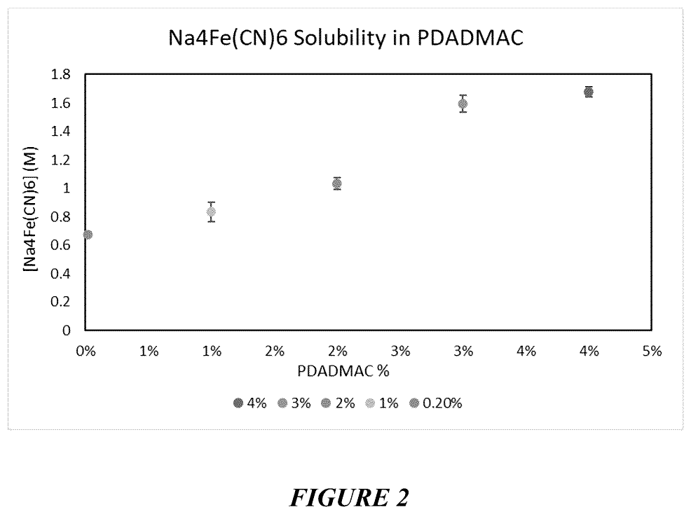

FIG. 2 also illustrates the impact of an increased wt. % of polyion additive on the concentration of ferrocyanide in an aqueous electrolyte solution configured in accordance with embodiments described herein. More specifically, the aqueous electrolyte solution of FIG. 2 includes sodium ferrocyanide and PDADMAC. The graph of FIG. 2 shows how as the amount of PDADMAC additive in the aqueous electrolyte solution increases (from 0.2 wt. % to 4 wt. %), the possible concentration of sodium ferrocyanide increase from about 0.7 M to as much as 1.7 M.

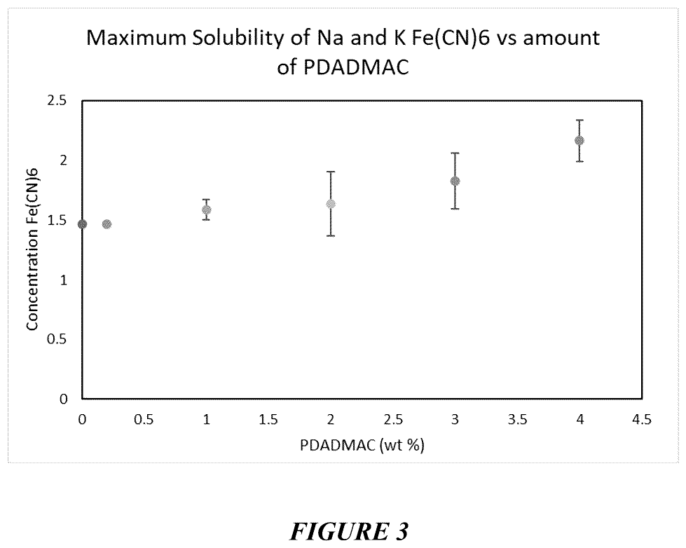

FIG. 3 also illustrates the impact of an increased wt. % of polyion additive on the concentration of ferrocyanide in an aqueous electrolyte solution configured in accordance with embodiments described herein. More specifically, the aqueous electrolyte solution of FIG. 3 includes a combination of potassium ferrocyanide and sodium ferrocyanide and PDADMAC. The graph of FIG. 3 shows how as the amount of PDADMAC additive in the aqueous electrolyte solution increases (from 0 wt. % to 4 wt. %), the possible concentration of sodium ferrocyanide increase from about 1.5 M to as much as 2.2 M.

In some embodiments, an aqueous electrolyte solution generally comprises one or more ferricyanides and an additive, wherein the additive is one or more polyion polymers, such as one or more polycation polymers, one or more polyanion polymers, or a combination of one or more polycation polymer and one or more polyanion polymers. The ferricyanide may be sodium ferricyanide, potassium ferricyanide, or a combination thereof. Some polyion polymer additives increase the solubility of the ferricyanide component or components of the aqueous electrolyte solution. As a result of the increased solubility, the concentration of the active species (ferricyanide) in the electrolyte solution is increased, and as such, less electrolyte solution is needed to power a battery. Some polyion polymer additives decrease the solubility of the ferricyanide component or components of the aqueous solution may be decreased. As a result of the decreased solubility, solids or gels of the ferricyanide can be isolated for purposes such as redox mediation.

The ferricyanide component of the aqueous electrolyte solution is, in some embodiments, either sodium ferricyanide, potassium ferricyanide, or a combination of both sodium ferricyanide and potassium ferricyanide. Additional ferricyanides may be included in the aqueous electrolyte solution, but typically only as supplements to the sodium ferricyanide and/or potassium ferricyanide. In some embodiments, these supplemental ferricyanides are selected from lithium ferricyanide, calcium ferricyanide, ammonium ferricyanide, or any combination thereof. In one non-limiting example, the aqueous electrolyte solution comprises both sodium ferricyanide and potassium ferricyanide and at least one additional supplemental ferricyanide (e.g., one or more of lithium ferricyanide, calcium ferricyanide, and ammonium ferricyanide). When a supplemental ferricyanide is included in the aqueous electrolyte solution, the amount of supplemental ferricyanide included in the aqueous electrolyte solution is less than the amount of primary ferricyanide (i.e., sodium ferricyanide, potassium ferricyanide, or combination thereof).

The additive component of the ferricyanide aqueous electrolyte solution is one or more polyion polymers. The polyion polymer additive included in the ferricyanide aqueous electrolyte solution may be one or more polycation polymers, one or more polyanion polymers, or a combination of one or more polycation polymers and one or more polyanion polymers.

When the additive includes one or more polycation polymers, any suitable polycation or polycations can be used. In some embodiments, a polycation polymer used as an additive comprises one or more functional groups, such as one or more functional groups selected from the group consisting of amines, imidazoles, pyridiniums, phenols, amides, ammonium groups, phosphonium groups, sulfonium groups, nitronium groups, and carbonyls. The polycation polymer may also include any other functional groups that can serve as a buffer.

In some embodiments, the polycation or polycations used in the aqueous electrolyte solution are polyquaterniums. The chemical structure of the polyquaternium suitable for use in the aqueous electrolyte solution described herein may be as follows:

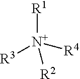

When the additive is a polyquaternium, any suitable polyquaternium may be used, including any of polyquaternium-1 through polyquaternium-47, including any combination of polyquaternium.

When the additive includes one or more polyanion polymers, any suitable polyanion or polyanions can be used. In some embodiments, a polyanion polymer used as an additive comprises one or more functional groups, such as one or more functional groups selected from the group consisting of amines, carboxylic acids, phosphates, imidazoles, phenols, amides, sulfates, nitrates, hydroxides, carbonates, dichromates, chromates, thiosulfates, dihydrogen phosphates, oxalates, carbonyls, and saccharides. In some embodiments, the polyanion polymer is selected from the group consisting of polysaccharides, poly(carboxylates), poly(phosphates), and poly(sulfates).

The use of some polyion polymers as an additive may generally help achieve a decrease in ferricyanide concentration in the aqueous electrolyte solution. As a result of the decreased solubility, solids or gels of the ferricyanide can be isolated for purposes such as redox mediation. A non-limiting example of a polyion that decrease ferricyanide concentration in the aqueous electrolyte solution is polyquaternium 7 (poly(acrylamide-co-diallyldimethylammonium chloride)). The solubility of sodium ferricyanide and potassium ferricyanide decreases with as little as 1% polyquaternium 7 added.

The amount of polyion additive included in the aqueous electrolyte solution is generally sufficient to increase or decrease the solubility of the ferricyanide in the aqueous electrolyte solution. In some embodiments, a quantity of at least 0.2 wt. % of polyion additive in the aqueous electrolyte solution shows in increase or decrease in the solubility of ferricyanide in the aqueous electrolyte solution. In some embodiments, the amount of polyion additive in the aqueous electrolyte solution is greater than 1 wt. %, greater than 2 wt. %, greater than 3 wt. %, or greater than 4 wt. % of the aqueous electrolyte solution. Increasing the amount of polyion additive in the aqueous electrolyte solution can generally allow for an increase or decrease in the concentration of ferricyanide in the aqueous electrolyte solution.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. An aqueous electrolyte composition comprising:
one or more ferrocyanides; and
an additive, wherein the additive comprises one or more polyion polymers.

2. The aqueous electrolyte composition of claim 1, wherein the one or more ferrocyanides comprises sodium ferrocyanide.

3. The aqueous electrolyte composition of claim 1, wherein the one or more ferrocyanides comprises potassium ferrocyanide.

4. The aqueous electrolyte composition of claim 1, wherein the one or more ferrocyanides comprises potassium ferrocyanide and sodium ferrocyanide.

5. The aqueous electrolyte composition of claim 2, wherein the one or more ferrocyanides further comprises one or more of lithium ferrocyanide, calcium ferrocyanide, and ammonium ferrocyanide.

6. The aqueous electrolyte composition of claim 3, wherein the one or more ferrocyanides further comprises one or more of lithium ferrocyanide, calcium ferrocyanide, and ammonium ferrocyanide.

7. The aqueous electrolyte composition of claim 4, wherein the one or more ferrocyanides further comprises one or more of lithium ferrocyanide, calcium ferrocyanide, and ammonium ferrocyanide.

8. The aqueous electrolyte composition of claim 1, wherein the one or more polyion polymers comprises one or more polycation polymers.

9. The aqueous electrolyte composition of claim 8, wherein the polycation polymer comprises one or more functional groups selected from the group consisting of amines, imidazoles, pyridiniums, phenols, amides, ammonium groups, phosphonium groups, sulfonium groups, nitronium groups, and carbonyls.

10. The aqueous electrolyte composition of claim 8, wherein the polycation polymer comprises a polyquarternium.

11. The aqueous electrolyte composition of claim 10, wherein the polyquarternium comprises poly(diallyldimethylammonium chloride) (PDADMAC).

12. The aqueous electrolyte composition of claim 1, wherein the one or more polyionic polymers comprises one or more polyanion polymers.

13. The aqueous electrolyte composition of claim 12, wherein the polyanion polymer comprises one or more functional groups selected from the group consisting of amines, carboxylic acids, phosphates, imidazoles, phenols, amides, sulfates, nitrates, hydroxides, carbonates, dichromates, chromates, thiosulfates, dihydrogen phosphates, oxalates, carbonyls, and saccharides.

14. The aqueous electrolyte composition of claim 1, wherein the one or more polyionic polymers comprises at least one polycation polymer and at least one polyanion polymer.

15. The aqueous electrolyte composition of claim 1, wherein the amount of additive in the aqueous electrolyte composition is equal to or greater than 0.2 wt. % of the aqueous electrolyte composition.

16. The aqueous electrolyte composition of claim 1, wherein the concentration of the ferrocyanide in the aqueous electrolyte composition is greater than 0.7 M.

17. The aqueous electrolyte composition of claim 1, wherein the aqueous electrolyte composition results in solid or gel formation.

18. An aqueous electrolyte composition comprising:
one or more ferricyanides; and
an additive, wherein the additive comprises one or more polyion polymers.

19. The aqueous electrolyte composition of claim 18, wherein the aqueous electrolyte composition results in solid or gel formation.
